(19) United States
(12) Patent Application Publication
(10) Pub. No.: US 2015/0022729 A1
(43) Pub. Date: Jan. 22, 2015

(54) LAYERED ASSEMBLY OF TOUCH PANEL

(71) Applicant: Teh-Zheng Lin, Taoyuan (TW)

(72) Inventor: Teh-Zheng Lin, Taoyuan (TW)

(21) Appl. No.: 13/947,117

(22) Filed: Jul. 22, 2013

(51) Int. Cl. G06F 3/041

(52) U.S. Cl. CPC G06F 3/041
USPC 349/12

(57) ABSTRACT

A layered assembly of a touch panel comprises an upper substrate being a transparent film; a colored frame being on an edge of the upper substrate or covering a whole surface of the upper substrate; at least one transparent touch sensor having an upper sensing layer and a lower sensing layer; a lower substrate being a transparent film. The upper sensing layer of the touch sensor is installed below the lower colored frame and the upper substrate; the lower sensing layer of the touch sensor being installed on an upper surface of the lower substrate; and an insulating gluing layer being installed between the upper sensing layer and the lower sensing layer; and signal wires at edges of the touch sensor being exactly below the colored frame.

The present invention is a continuation in part of U.S. Pat. No. 12/852,531 which is assigned to the applicant of the present invention and thus the content of U.S. Pat. No. 12/852,531 is incorporated into the present invention as a part of the present invention.

### FIELD OF THE INVENTION

The present invention related to a layered assembly of a touch panel, in particular to a transparent touch panel which can be installed in front of a display screen so that the use can operate interactively through the touch panel.

### BACKGROUND OF THE INVENTION

Touch panels are widely used in commercial electronic devices, such as handsets, digital cameras, MP3s, PDAs, GPSs, etc. Touch panels are arranged on the screens of these electronic devices so that the users can input interactively. Thus a user friendly environment between users and devices is provided and the input efficiency to an electronic device is increased. For example, see FIGS. 7 and 8, in installation of a prior art touch panel, a decorating panel 600 is adhered upon a touch sensing plate 500. Then they are adhered to a display screen. In general, the sensing plate 500 has a touch sensor 501 which is insulatedly clamped between an upper substrate 502 and a lower substrate 503. The decorating panel 600 is a transparent plate. An edge on the surface thereof is adhered with a frame 601 so as to shield the signal wires 501a at edges of the touch sensors to have a beautiful outlook. However, since in manufacturing process, the decorating panel 600 and the touch sensing plate 500 are made individually and then a gluing layer (optical glue) 700 is used to adhere the two to one. Not only the assembly process is tedious, but also the optical glue is expensive. In adhering, bad products are easily formed to cause waste of material and the cost is increased. Furthermore, after assembly, the thickness of the touch panel is doubled. Thus it is not light and thin. Further, the optical property of the panel is deteriorated. Therefore, the prior art touch panels are needed to be improved.

### SUMMARY OF THE INVENTION

Accordingly, the object of the present invention is to provide a layered structure of a touch panel, in that a substrate of a touch panel is installed with a colored frame and a touch sensor so as to reduce the manufacturing process in gluing process and the yield ratio is increased. Furthermore, optical property is improved so as to match the requirement of light, thin and compact sized of a touch panel.

To achieve above object, the present invention provides a layered assembly of a touch panel, comprising: an upper substrate being a transparent film; a colored frame being on an edge of the upper substrate or covering a whole surface of the upper substrate; at least one transparent touch sensor having an upper sensing layer and a lower sensing layer; a lower substrate being a transparent film; wherein the upper sensing layer of the touch sensor being installed below the lower colored frame and the upper substrate; the lower sensing layer of the touch sensor being installed on an upper surface of the lower substrate; and an insulating gluing layer being installed between the upper sensing layer and the lower sensing layer; and signal wires at edges of the touch sensor being exactly below the colored frame.

Materials of the upper substrate and lower substrate are transparent and are selected from one of glass, polycarbonate (PC), polyester (PET), PMMA, or cyclic olefin copolymers (COC).

The upper substrate and lower substrate are planer or non-planer thin plates.

The material of the colored frame is selected from ink, colored photo-resistors, organic material and inorganic material.

The touch sensor is selected from one of the capacitive touch sensors, resistive touch sensors, and electromagnetic touch sensors, or the combination thereof.

A grounding layer is installed below the lower transparent substrate which is made of transparent conductive material selected from indium tin oxide, indium zinc oxide, and zinc aluminum oxide.

A transparent protection layer is installed below the upper substrate and the colored frame; and material of the transparent protection layer is selected from one of silicone nitride, silicone dioxide, and photo-resistors.

The layered assembly of a touch panel further comprises a function film installed at an upper surface of the upper substrate.

The function film is one of an atomized film and a hard coating film.

The function film is a light adjustment layer which is formed by at least one of polarizing film, phase difference film or optical omni-directional film.

The various objects and advantages of the present invention will be more readily understood from the following detailed description when read in conjunction with the appended drawing.

### BRIEF DESCRIPTION OF THE DRAWINGS

FIG. 1A is a cross sectional view of the first embodiment of the present invention, wherein the colored frame covers the whole surface of the upper substrate.

FIG. 1B is a cross sectional view of the first embodiment of the present invention, wherein the colored frame covers a part of the upper substrate;

FIG. 2 is a cross sectional view of the first embodiment of the present invention, wherein the touch panel is installed in front of a display screen;

FIG. 3 is a cross sectional view about the second embodiment of the present invention.

FIG. 4A is a cross sectional view about the third embodiment of the present invention.

FIG. 4B is a cross sectional view about another assembly of the third embodiment of the present invention.

FIG. 5A is a cross section view about the fourth embodiment of the present invention.

FIG. 5B is a cross section view about another assembly of the fourth embodiment of the present invention.

FIG. 5C is a cross section view about a further assembly of the fourth embodiment of the present invention.

FIG. 5D is a cross section view about a yet assembly of the fourth embodiment of the present invention.

FIG. 6A is a schematic view about the fifth embodiment of the present invention.

FIG. 6B is a schematic view about another assembly of the fifth embodiment of the present invention.

FIG. 6C is a cross section view about a further assembly of the fifth embodiment of the present invention.

FIG. 6D is a cross section view about a yet assembly of the fifth embodiment of the present invention.

FIG. 7 is a schematic view about the prior art touch panel.

FIG. 8 is a schematic view about element structure of the prior art touch panel.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

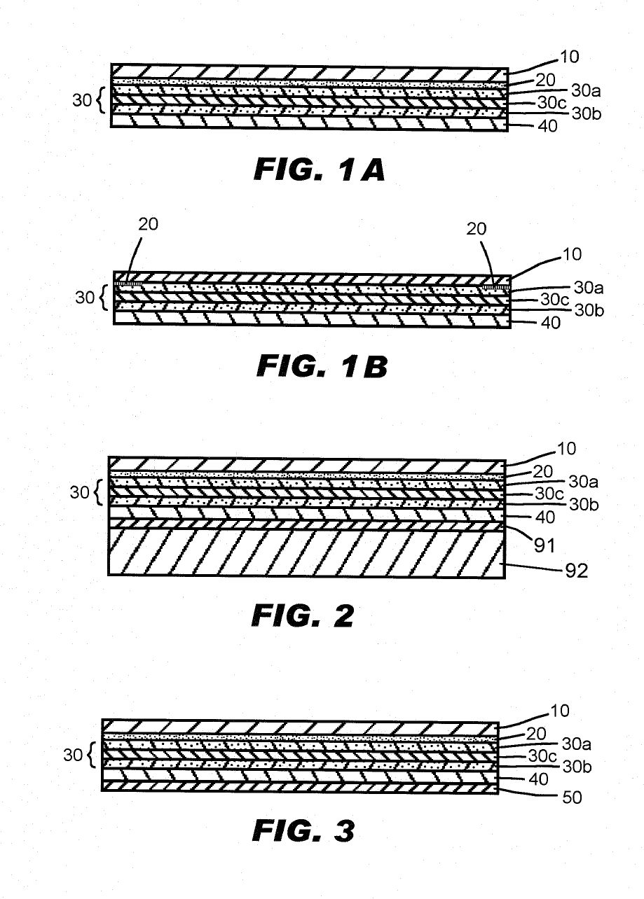

With reference to FIG. 1, the first embodiment of the present invention is illustrated. In this the present invention, a capacitive touch panel is used as an example. However, the present invention is also suitable for resistive touch panels or electromagnetic touch panels.

In the present invention, the touch panel includes an upper transparent substrate 10, a color frame 20, a touch sensor 30 and a lower transparent substrate 40 which are sequentially arranged. The upper transparent substrate 10 and lower transparent substrate 40 are made of transparent material which is selected from flexible thin plate, such as glass, polycarbonate (PC), polyester (PET), PMMA, or cyclic olefin copolymers (COC), etc. However, these are not used to confine the scope of the present invention. Various kinds of hard or soft transparent, semi-transparent substrate are also suitable in the present invention. The upper transparent substrate and lower transparent substrate 10, 40 are made of same or different material. The colored frame 20 contains inks, color optical resistor, organic material or inorganic material, but these are not used to confine the scope of the present invention. The colored frame 20 is formed as a thin film with a thickness of about 1 μm. In real state, the colored frame 20 may cover the whole surface of the upper transparent substrate 10 as illustrated in FIG. 1A, or the color frame 20 only covers a part of the surface of the upper transparent substrate 10, including to cover an upper edge of the upper transparent substrate 10, as illustrated in FIG. 1B. All these structures are within the scope of the present invention.

The touch sensor 30 is a capacitive touch sensor which includes an X axis sensing layer 30a, a Y axis sensing layer 30b and an insulation layer 30c which is installed between the X axis sensing layer 30a and the Y axis sensing layer 30b. The X axis sensing layer 30a and the Y axis sensing layer 30b are grounded and are connected to a control circuit (not shown). The X axis sensing layer 30a and Y axis sensing layer 30b are made of silicone tin oxide (ITO). The insulation layer 30c is an insulation gluing layer. The X axis sensing layer 30a and Y axis sensing layer 30b, and insulation layer 30c are transparent layers.

The X axis sensing layer 30b can be directly made upon the colored frame 20 of the transparent substrate 10. When the frame 20 only covers a part of the transparent substrate 10, the X axis sensing layer 30a will flow through the hollows of the colored frame 20 so as to contact with the transparent substrate 10.

The Y axis sensing layer 30b is installed on the surface of the lower transparent substrate 40. Thus, the conductive wires at edges of the touch sensor 30 are exactly below the colored frame 20. As a result, the colored frame 20 will shield the conductive wires to have a beautiful outlook,

Referring to FIG. 2, it is illustrated that above mentioned touch panel is installed in front of a display 92 by using a gluing layer 91. In operation, when the touch panel is touched by a finger or a conductor, the capacitive touch sensor 30 will generate a capacitive signal. The variation of the signal is used to detect the position of the finger or the conductor. As comparing the present invention with the prior art, it is known that the upper sensing layer 30a is directly formed on the colored frame 20 and the lower sensing layer 30b is directly formed on the lower transparent substrate 40. Then the two are combined through the insulation layer 30c. In the gluing processes in the prior art substrate of the touch panel, surface decoration plate and all the sensing layers are not used in the present invention so that the cost is down and yield rate is increased. Meanwhile, the optical property is improved and the product can be thinned.

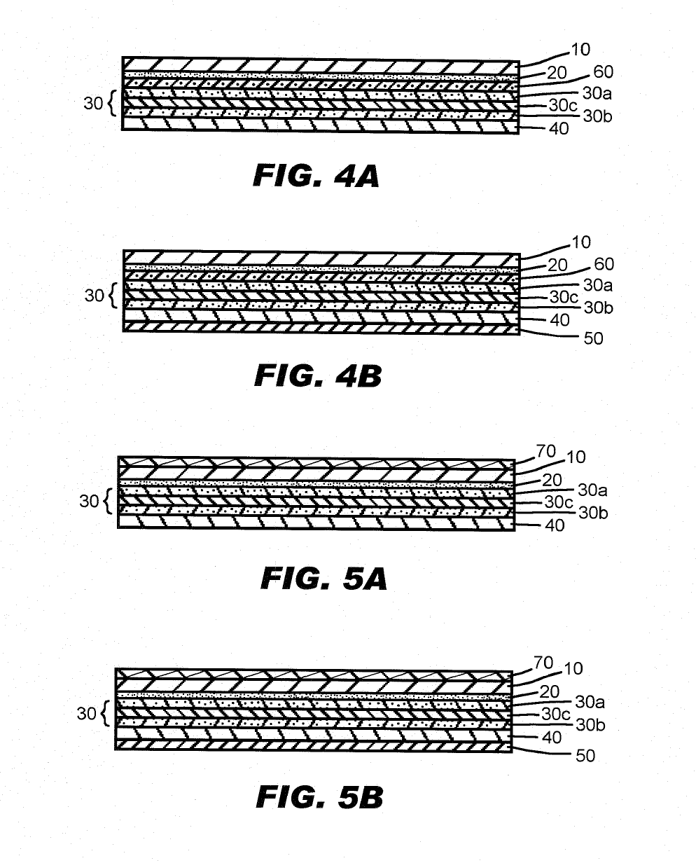

Furthermore, the structure in the first embodiment can be adjusted by the use of the touch panel. For example, as the second embodiment illustrated in FIG. 3, a grounding layer 50 is installed below the lower transparent substrate 40 which is made of transparent conductive material, such as indium tin oxide, indium zinc oxide, and zinc aluminum oxide, etc. By the grounding layer, the grounding potential can be retained so that the electromagnetic interference to the touch sensor 30 can be avoided. The third embodiment of the present invention is illustrated in FIG. 4A, based on the structure illustrated in first embodiment, a transparent protection layer 60 is installed between the colored frame 20 (in the case of FIG. 1B, the transparent protection layer 60 will contact the transparent substrate 10) and the X axis sensing layer 30a so as to increase the flatness in combination of different layers. The material of the transparent protection layer 60 is selected from silicone nitride, silicone dioxide, and other optical resistor, however, these are not used to confine the scope of the present invention. In another assembly illustrated in FIG. 4B about the third embodiment of the present invention, other than a transparent protection layer 60 is installed, a grounding layer 50 is installed below the transparent substrate 40.

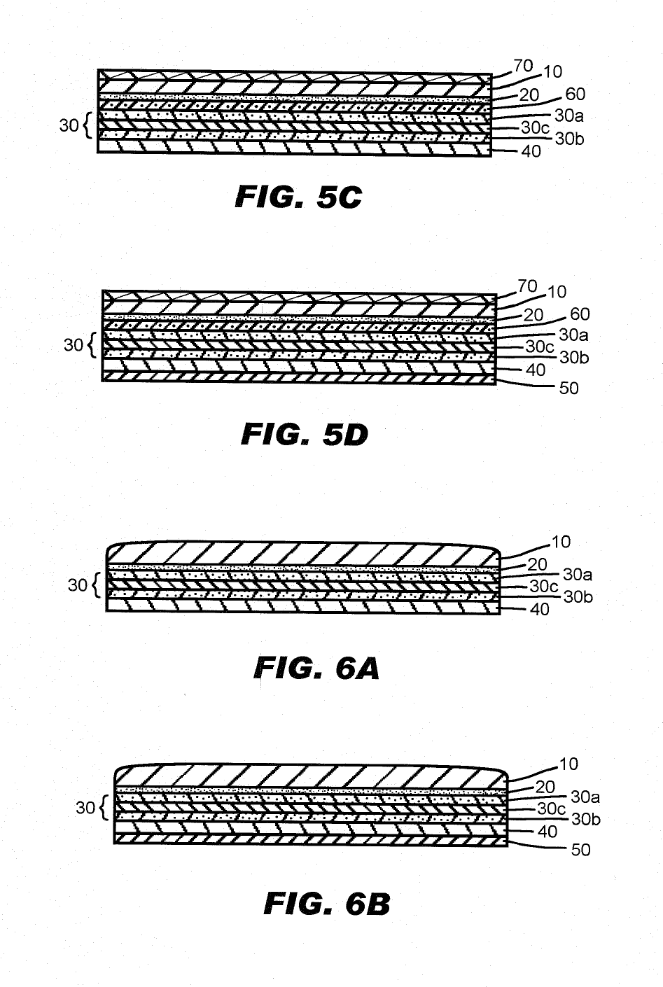

FIG. 5A shows the fourth embodiment of the present invention. According to the first embodiment, a function film 70 is installed upon an upper surface of the transparent substrate 10 which is an atomized film or a hard coating layer for reducing light reflection ratio on the surface of the touch panel or increase the hardness of the surface of the panel. The functional film 70 may be a film with a function of light adjustment which is formed by optical film selected from at least one of such as polarizing film, phase difference film or optical omni-directional film, etc. for improving the viewing effect of the screen. FIGS. 5B to 5D show the fourth embodiment of the present invention. Other than the function film 70, at least one of the transparent protection layer and the grounding layer can be added.

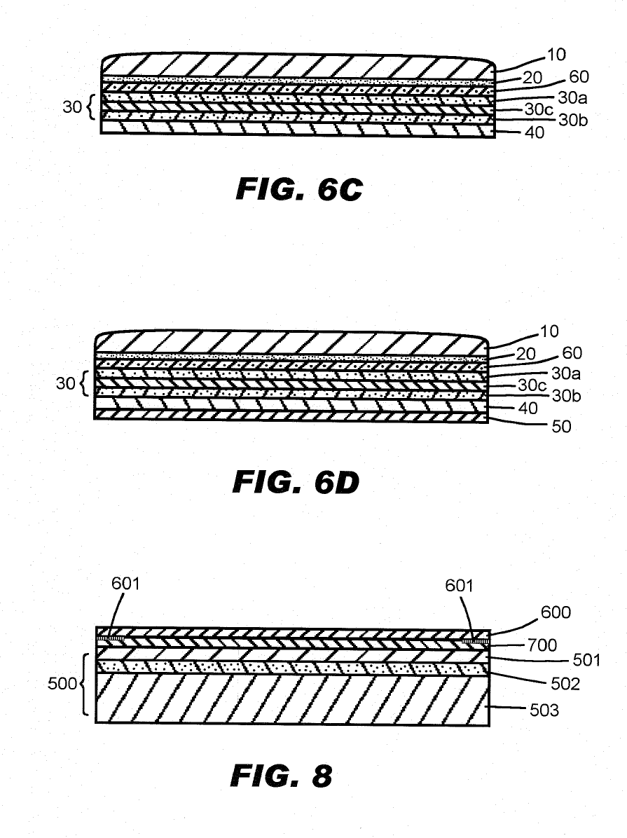

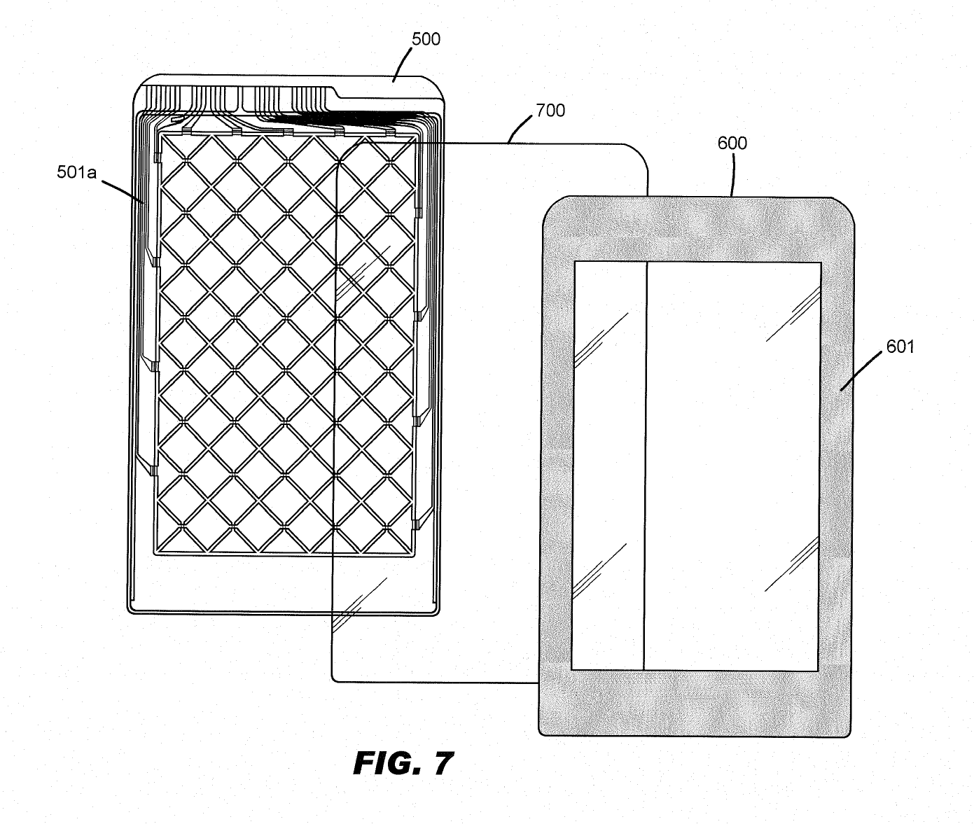

Other than above mentioned structure, other variations within the scope of the present invention are also include in the present invention, for example, other than the planar transparent substrate 10, non-planer transparent substrate 10, such as cambered transparent substrate, can be used for matching the requirement of the installation of the touch panels (such as the cases illustrated in FIGS. 6A to 6D).

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A layered assembly of a touch panel, comprising:
an upper substrate being a transparent film;
a colored frame being on an edge of the upper substrate or covering a whole lower surface of the upper substrate;
at least one transparent touch sensor having an upper sensing layer and a lower sensing layer;
a lower substrate being a transparent film;
wherein the upper sensing layer of the touch sensor being installed below the colored frame and the upper substrate; the lower sensing layer of the touch sensor being installed on an upper surface of the lower substrate;
and an insulating gluing layer being installed between the upper sensing layer and the lower sensing layer; and signal wires at edges of the touch sensor being exactly below the colored frame.

2. The layered assembly of a touch panel as claimed in claim 1, wherein materials of the upper substrate and lower substrate are transparent and are selected from one of glass-glass, polycarbonate (PC), polyester (PET), PMMA, or cyclic olefin copolymers (COC).

3. The layered assembly of a touch panel as claimed in claim 1, wherein the upper substrate and lower substrate are planer or non-planer thin plates.

4. The layered assembly of a touch panel as claimed in claim 1, wherein the material of the colored frame is selected from ink, colored photo-resistors, organic material and inorganic material.

5. The layered assembly of a touch panel as claimed in claim 1, wherein the touch sensor is selected from one of the capacitive touch sensors, resistive touch sensors, and electromagnetic touch sensors, or the combination thereof.

6. The layered assembly of a touch panel as claimed in claim 1, wherein a grounding layer is installed below the lower transparent substrate which is made of transparent conductive material selected from indium tin oxide, indium zinc oxide, and zinc aluminum oxide.

7. The layered assembly of a touch panel as claimed in claim 1, wherein a transparent protection layer is installed below the upper substrate and the colored frame; and material of the transparent protection layer is selected from one of silicone nitride, silicone dioxide, and photo-resistors.

8. The layered assembly of a touch panel as claimed in claim 1, further comprising: a function film installed at an upper surface of the upper substrate.

9. The layered assembly of a touch panel as claimed in claim 8, wherein the function film is one of an atomized film and a hard coating film.

10. The layered assembly of a touch panel as claimed in claim 8, wherein the function film is a light adjustment layer which is formed by at least one of polarizing film, phase difference film or optical omni-directional film.
